(19) United States
(12) Patent Application Publication
(10) Pub. No.: US 2023/0158608 A1
(43) Pub. Date: May 25, 2023

(54) EQUIPMENT AND METHOD FOR CUTTING SUBSTRATE

(71) Applicant: Skiileux Electricity Inc., Taoyuan City (TW)

(72) Inventor: Chih-Cheng Wang, Taoyuan City (TW)

(73) Assignee: Skiileux Electricity Inc., Taoyuan City (TW)

(21) Appl. No.: 17/889,349

(22) Filed: Aug. 16, 2022

(30) Foreign Application Priority Data
Nov. 22, 2021 (TW) 110143363

(51) Int. Cl. B23K 26/38

(52) U.S. Cl. CPC B23K 26/38

(57) ABSTRACT

A method for cutting substrate includes the steps of forming a cutting path on a substrate, applying a laser beam onto the substrate to form a plurality of holes with a pitch less than or equal to 20 micro meters along the cutting path, increasing the temperature of an area of the substrate containing the plurality of holes, and if necessary, applying force to separate the substrate along the plurality of holes. An equipment for cutting substrate includes a carrying platform, a laser generating device, a heating device, and a control module. The carrying platform is used for carrying a substrate. The laser generating device can generate a laser beam. The control module can control the laser beam generated by the laser generating device to move on the substrate along a track, and then guide the heating device to heat the substrate along the track.

### BACKGROUND OF THE INVENTION

### 1. Field of the Invention

The present invention relates to a laser cutting method and equipment, and more particularly to a laser cutting method and equipment for cutting a substrate.

### 2. Description of the Prior Art

Laser cutting mainly uses the laser to evaporate the material, so as to cut a workpiece. Laser cutting can be achieved by a variety of ways to adapt different cutting conditions. For example, for the cutting of the substrate, an ablation method can be used, but the cutting speed is slow because the laser is used to heat (that is, the material absorbs the laser) and vaporize the material on the entire cutting path. If the laser is used to form cutting grooves on only one side surface of the substrate, the cutting speed can be accelerated. Then, by aligning with the defect zone, an external force can be applied to the substrate (i.e. the other side of the substrate opposite to the surface) (e.g., using a cleaving knife to contact the substrate in a vibrating manner) to completely split the substrate. For another example, there is also a case of cutting the substrate by a cracking method, which heats the interior of the substrate with a laser to generate a defect zone inside the substrate, and then aligns the defect zone and applies an external force to the substrate to completely split the substrate (for example, by the above cleaving knife to cleave the substrate). The cut sheets by the above laser cutting groove/crack method and mechanical cleaving are prone to irregular cutting tracks and uneven cutting planes. When the expected size of the cut sheets is small, the above irregular cutting tracks and uneven cutting planes will easily damage the cut sheets, even to scrap it.

### SUMMARY OF THE INVENTION

An objective of the invention is to provide a method for cutting substrate. The method for cutting substrate uses a laser beam to form holes and heat the area containing the holes to make the holes produce cracks and make the cracks propagate, which is convenient for splitting the substrate.

A method for cutting substrate according to the invention includes: forming a cutting path on a substrate; applying a laser beam onto the substrate to form a plurality of holes with a pitch less than or equal to 20 micro meters along the cutting path; and increasing a temperature of an area of the substrate containing the plurality of holes. Therein, the laser beam also produces a plurality of cracks due to thermoelastic stress while forming the plurality of holes. Increasing the temperature of the area of the plurality of holes can make the plurality of cracks propagate, which helps the plurality of cracks to be connected along the cutting path, thereby facilitating the splitting of the substrate.

Another objective of the invention is to provide equipment for cutting substrate. The equipment for cutting substrate can provide a laser beam to form material defects in the substrate and heat the substrate to produce cracks in the substrate and make the cracks propagate, which is convenient for splitting the substrate.

The equipment for cutting substrate according to the invention includes a carrying platform, a laser generating device, a heating device, and a control module. The carrying platform is used to carry a substrate. The laser generating device can generate a laser beam. The control module can control the laser beam generated by the laser generating device to move on the substrate along a track, and the control module then guides the heating device to heat the substrate along the track. Therein, the control module can control the laser beam to irradiate the substrate, carried on the carrying platform, along the track to make the substrate produce cracks due to thermoelastic stress. The control module guides the heating device to heat the cracks to propagate, which is convenient for splitting the substrate.

Compared with the prior art, the method for cutting substrate and the equipment for cutting substrate according to the invention can form holes and cracks on the substrate and expend the cracks, so that the substrate can be completely separated approximately along the cutting path or track. The method for cutting substrate and the equipment for cutting substrate can effectively split the substrate, either without the use of tools (e.g. a cleaving knife) or with only a small external force (which can be significantly less than the force required to split the substrate with a cleaving knife in the prior art), which can effectively solve or reduce the problems in the prior art that the cut sheets cut by using the laser cutting groove/crack method and mechanical cleaving are prone to irregular cutting tracks and uneven cutting planes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart of a method for cutting substrate according to a first embodiment.

FIG. 2 is a schematic diagram illustrating a substrate to be cut according to the first embodiment.

FIG. 3 is a schematic diagram illustrating forming holes on the substrate in FIG. 2.

FIG. 4 is a top view of the substrate in FIG. 3 after heated.

FIG. 5 is a top view of the substrate in FIG. 4 after a film on which the substrate is disposed is stretched.

FIG. 6 is a flow chart of a method for cutting substrate according to a second embodiment.

FIG. 7 is a component configuration diagram of equipment for cutting substrate according to the third embodiment.

FIG. 8 is a schematic diagram illustrating the equipment for cutting substrate in FIG. 7 provided with the substrate thereon.

### DETAILED DESCRIPTION

### First Embodiment

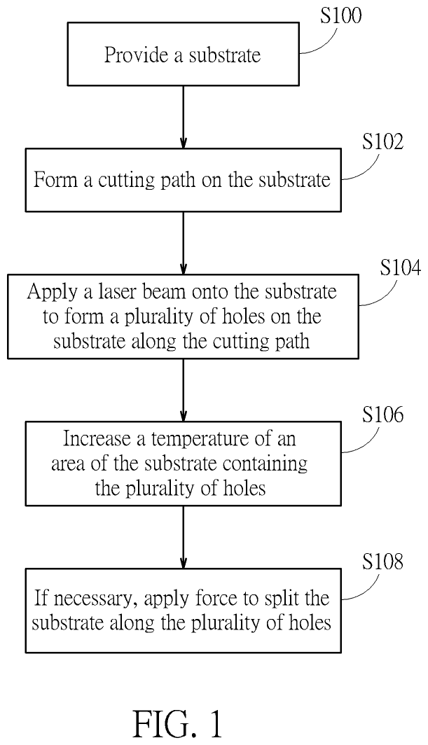

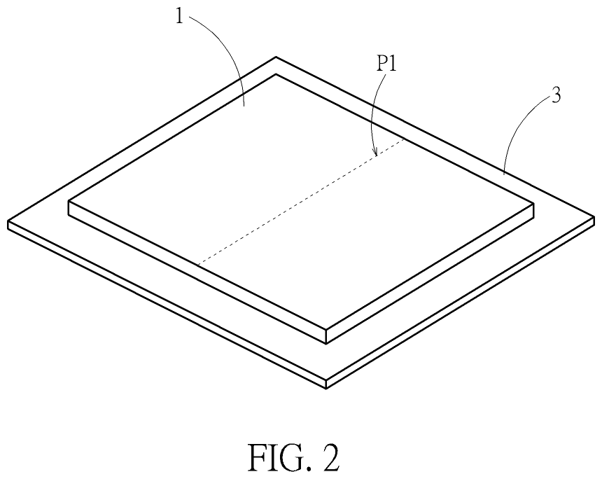

Please refer to FIG. 1 to FIG. 3. A method for cutting substrate according to a first embodiment is to provide a substrate 1, as shown by the step S100. Then, as shown by the step S102, a cutting path P1 (indicated by a dashed line in FIG. 2) is formed on the substrate 1. In practice, the cutting path P1 can be a virtual path or a path formed by structures on substrate 1, such as a structural pattern formed between components (such as light-emitting diodes, but not limited to light-emitting diodes) carried on the substrate 1. For simplification of the description, the cutting path P1 is shown by a single straight line as an example, but in practice, the cutting path P1 can also be a curve or other shapes.

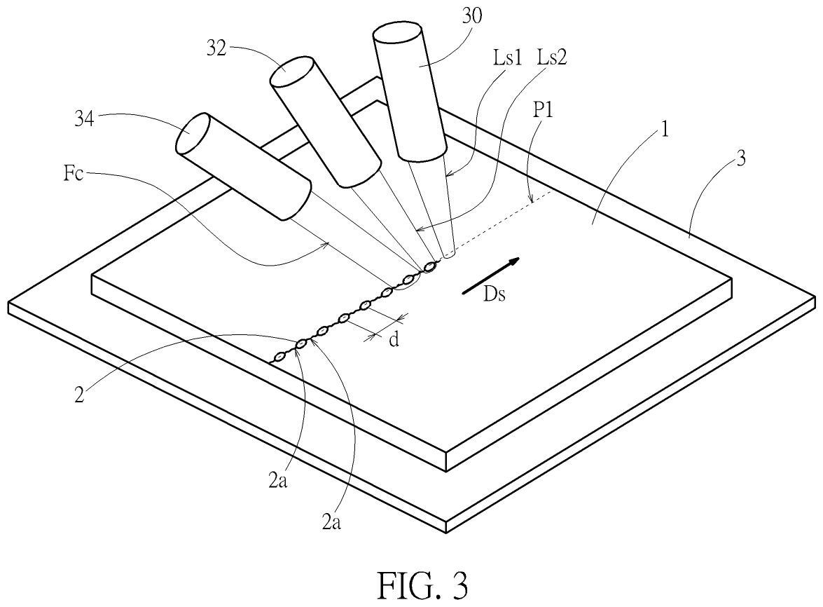

Then, as shown by the step S104, a laser beam Ls1 is applied onto the substrate 1 to form a plurality of holes 2 (exaggeratedly shown in FIG. 3) with a pitch less than or equal to 20 micro meters along the cutting path P1. Therein, in practice, the laser beam Ls1 is generated by a laser generating device 30 and is focused on the substrate 1 to form the holes 2. For simplification of drawing, the laser generating device 30 is shown as a single component in the figure. In practice, the laser generating device 30 may include components such as a laser and a focusing lens set. For example, the laser beam Ls1 can be a pulse laser beam, but not limited to a pulse laser beam. For another example, the laser beam Ls1 is focused inside the substrate 1 in the form of a Bessel beam, the substrate 1 absorbs the energy of the laser beam Ls1 and causes thermoelastic stress. The thermoelastic stress in substrate 1 will cause longitudinal cracks to form the holes 2. However, the way of forming the holes 2 by the laser beam Ls1 is not limited to focusing the laser beam Ls1 in the form of a Bessel beam. The wavelength of the laser beam Ls1 depends on the material of the substrate 1. For example, the substrate 1 can be a glass material substrate, but is not limited to a glass material substrate. For another example, the substrate 1 can be a ceramic substrate or other brittle substrate. Furthermore, for example, a carbon dioxide (CO₂) laser can be used to cut glass substrates, but it is not limited to use a CO₂ laser beam to cut glass substrates. As shown by FIG. 3, the laser beam Ls1 moves (or scans) along the cutting path P1. Therein, a movement direction Ds of the laser beam Ls1 is shown by an arrow in the figure. In practice, when the cutting path P1 is a curve, the movement direction Ds is the tangent direction of the cutting path P1, which will not be described in addition. In the embodiment, the laser beam Ls1 has a pulse repetition rate and moves relative to the substrate 1 at a scanning speed. By setting the pulse repetition rate and scanning speed, the control of the pitch d of the holes 2 can be realized. In practice, the pitch d of the holes 2 can be set to be less than or equal to 20 micro meters, or less than or equal to other values, such as 10 micro meters, 15 micro meters, etc. less than 20 micro meters. Furthermore, the pitch d of the holes can be equidistant or non-equidistant, or partly equidistant, partly non-equidistant, etc. The inner diameter of holes 2 is smaller than 3 micro meters, or smaller than other values, such as 2 micro meters, 1 micro meters, etc., which are smaller than 3 micro meters. The holes 2 may be through holes passing through the substrate 1, but are not limited to through holes. Furthermore, by controlling the contour of the focus area of the laser beam Ls1, the thermoelastic stress in the substrate 1 can also cause lateral cracks 2a (exaggeratedly shown in FIG. 3) that propagate from the hole 2 approximately along the cutting path P1.

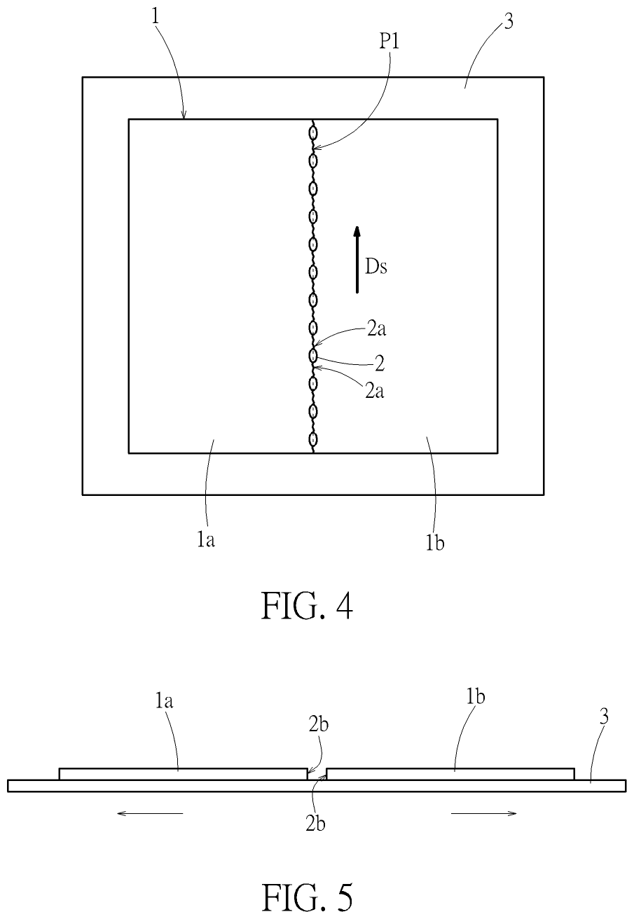

Then, as shown by the step S106, the temperature of an area of the substrate 1 containing the plurality of holes 2 is increased; for example, it can be achieved by using a heating device that can heat the substrate 1. The increase of temperature of the areas containing the holes 2 can again induce thermoelastic stress at the cracks 2a; this thermoelastic stress will make the cracks 2a to propagate, so that the cracks 2a between any adjacent two of the holes 2 can be close to each other and may be connected to each other, as shown in FIG. 4. Therein, as shown by FIG. 3, the above increase in the temperature increase of the substrate 1 containing the plurality of holes 2 area can be achieved by using another laser beam Ls2 (generated by another laser generating device 32 (i.e., used as a heating device)) to increase the temperature of the substrate 1; for example, the area of the substrate 1 containing the plurality of holes 2 is continuously heated along the cutting path P1 by using a CO₂ laser beam, but it is not limited to use a CO₂ laser as a heat source. For other descriptions of the laser generating device 32, please refer to the relevant descriptions of the laser generating device 30, which will not be repeated in addition.

When all adjacent cracks 2a are connected, the substrate 1 has been substantially cut into cut sheets 1a and 1b along the cutting path P1. In the embodiment, the substrate 1 is attached to a flexible film 3 before being irradiated with the laser beam Ls1, as shown in FIG. 2. The flexible film 3 includes an adhesive (not shown in the figure) coated thereon, and the substrate 1 is attached to the flexible film 3 via the adhesive. After the step S106, the method may apply force as needed to split the substrate 1 along the plurality of holes 2, as shown by the step S108 and FIG. 5. Therein, by stretching the flexible film 3 (e.g. pulling the flexible film 3 to the left and right sides as shown in FIG. 5), the cut substrate 1 can be separated along the plurality of holes 2 (or the cutting path P1). The plurality of holes 2 and cracks 2a form cutting planes 2b. In practice, an appropriate material can be selected for the adhesive, so as to reduce the viscosity of the adhesive after the steps S104 and S106 are performed, so that the cut sheets 1a and 1b of the substrate 1 can be removed from the flexible film 3 after the flexible film 3 is stretched. Alternatively, after the steps S104 and S106 are performed, the degumming step is additionally performed; for example, the adhesive is UV adhesive. After the steps S104 and S106 are performed, the substrate 1 is irradiated with UV to reduce the viscosity of the UV adhesive, which is also convenient for removing the cut sheets 1a and 1b of the substrate 1 from the flexible film 3 after the flexible film 3 is stretched.

### Second Embodiment

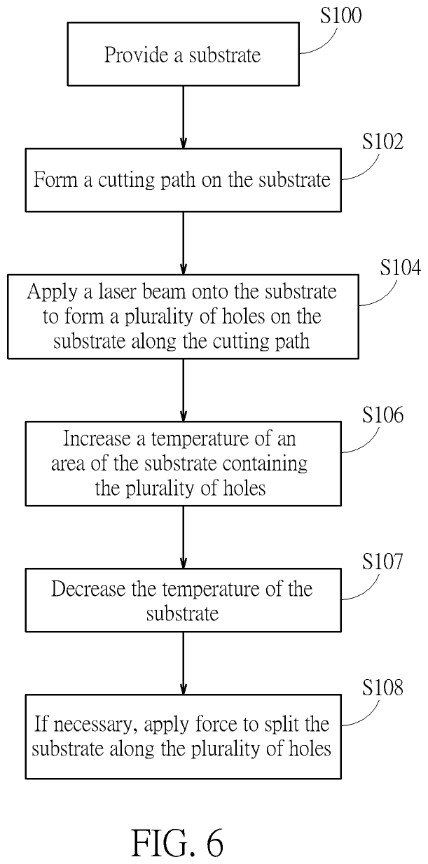

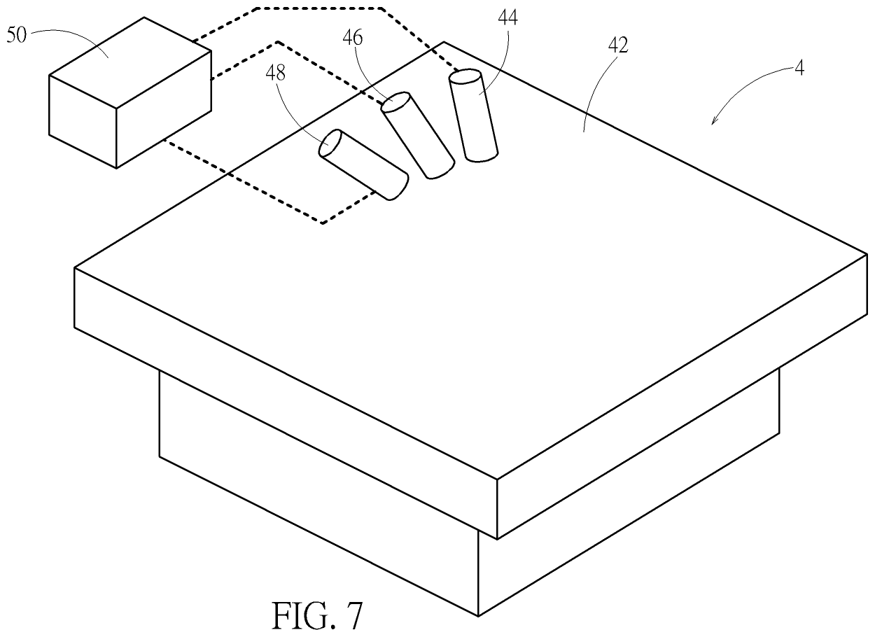

Please refer to FIG. 3 and FIG. 6. A method for cutting substrate according to a second embodiment is similar to the method for cutting substrate according to the first embodiment. For other descriptions of the method for cutting substrate according to the second embodiment, please refer to the above relevant descriptions in the foregoing, which will not be repeated. Compared with the method for cutting substrate according to the first embodiment, the method for cutting substrate according to the second embodiment is to decrease the temperature of the substrate after the temperature of the substrate is increased (i.e. the step S106), as shown by the step S107 in FIG. 6. In practice, the decrease of temperature of the substrate 1 can be achieved by directing a cooling air flow Fc (which is generated by a cooling device 34 which is simply shown as a single component in FIG. 3) to reduce the temperature of the substrate 1. As shown by FIG. 3, the cooling air flow Fc blows to the area of the substrate 1 containing the plurality of holes 2 along the cutting path P1. In the movement direction Ds, the cooling air flow Fc is located behind the laser beam Ls2. This configuration can make the cracks 2a cool immediately after being heated, resulting in a large temperature difference, which makes the temperature drop rate larger and enhances the propagation of the cracks 2a due to thermoelastic stress, so as to facilitate the connection of adjacent cracks 2a. Furthermore, in the case of synchronously controlling the laser generating devices 30 and 32 and the cooling device 34 (e.g. when the laser beams Ls1 and Ls2 and the cooling air flow Fc exist at the same time), when the cooling air flow Fc reaches the end of the cutting path P1, the irradiation range of the laser beams Ls1 and Ls2 has exceeded the cutting path P1, forming a pseudo-overcutting, which may cause unnecessary damage; for example, the laser beams Ls1 and Ls2 irradiate the flexible film 3, and the platform carrying the substrate 1 (together with the flexible film 3). A compact arrangement of the range irradiated by the laser beams Ls1 and Ls2 and the range blown by the cooling air flow Fc helps to reduce the degree of the above pseudo-overcutting.

Furthermore, in practice, the air flow temperature of the cooling air flow Fc is not limited to be lower than room temperature. When the air flow temperature of the cooling air flow Fc is a room temperature (e.g. a fan is used as the cooling device 34 and draws in ambient air and directs it to the substrate 1 as the cooling air flow Fc), the cooling air flow Fc still can make the temperature difference between the heated crack 2a and the room temperature, which can also enhance the propagation of the cracks 2a due to thermoelastic stress. Furthermore, the flowing velocity of the cooling air flow Fc also affects the cooling effect on the cracks 2a, which will not be described in addition. In principle, the faster cooling air flow flows, the greater the cooling of the cracks 2a, and the greater the propagation of the cracks 2a due to thermoelastic stress. In addition, the cooling of the substrate 1 by the cooling air flow Fc is not limited to local implementation (e.g. the cooling air flow Fc only blows to the area of the substrate 1 containing the plurality of holes 2). From another aspect, cooling the whole substrate 1 or a larger area of the substrate 1 can also reduce the temperature of the heated crack 2a at a certain rate, which still can enhance the propagation of the cracks 2a due to thermoelastic stress. Furthermore, in practice, the area where the laser beam Ls2 irradiates the substrate 1 and the area where the cooling air flow Fc blows to the substrate 1 can be as close as possible to increase the temperature drop rate and enhance the propagation of the cracks 2a due to thermoelastic stress.

As discussed above, the substrate 1 cut according to the first and second embodiments mainly utilizes the holes 2 and the cracks 2a to form the cutting planes 2b (referring to FIG. 5), rather than splitting the substrate by means of impact with the cleaving knife in the prior art. Therefore, the cutting planes 2b are relatively flat, and the surface roughness thereof can reach below 1.5 micro meters. In practice, the surface roughness of the cutting plane 2b can be controlled by setting the aperture and pitch d of the holes 2. In addition, in a few cases, even if not all adjacent cracks 2a can be connected by propagation, in principle, only a few adjacent cracks 2a are not connected. It is practicable to split the substrate 1 completely along the cutting path P1 by stretching the flexible film 3 or by applying a smaller external force (compared with the impact force with a cleaving knife in the prior art) to the substrate 1 with other cleaving tools (e.g. a cleaving knife).

In addition, in the first and second embodiments, both ends of the cutting path P1 extend to edges of the substrate 1 (i.e. across the substrate 1) to divide the substrate 1 into left and right parts (as shown in FIG. 4); however, it is not limited thereto in practice.

For example, the method for cutting substrate according to the invention can also be used to split the substrate 1 into inner and outer parts, e.g. designing the cutting path into a closed loop. For another example, the method for cutting substrate according to the invention can also be used to form cutting surface of a certain length on the substrate 1; for example, the cutting path is designed such that one or both ends of the cutting path are located inside the substrate 1, that is, the cutting path does not cross the substrate 1 and does not form a closed loop.

### Third Embodiment

Please refer to FIG. 7. Equipment 4 for cutting substrate according to a third embodiment includes a carrying platform 42, a laser generating device 44, a heating device 46, a cooling device 48, and a control module 50 (simplified as a single block in the figure). The control module 50 is electrically connected (shown in bold dashed lines in the figure) to the laser generating device 44, the heating device 46, and the cooling device 48 and controls the operation of the laser generating device 44, the heating device 46, and the cooling device 48. The control module 50 may be achieved by hardware (e.g. including a circuit board, and a processing chip, a communication chip, a connection interface, and other required electronic components which are carried on the circuit board), software, or a combination thereof, which will not be described in addition. The carrying platform 42 is used for carrying a substrate. The laser generating device 44 can generate a laser beam; for other descriptions of the laser generating device 44, please refer to the relevant descriptions of the laser generating device 30 in the foregoing, which will not be repeated in addition. For simplification of the description, the use of the equipment 4 is described using the method of the second embodiment. For the relevant description of this method, please refer to the relevant description in the foregoing, which will not be repeated in addition.

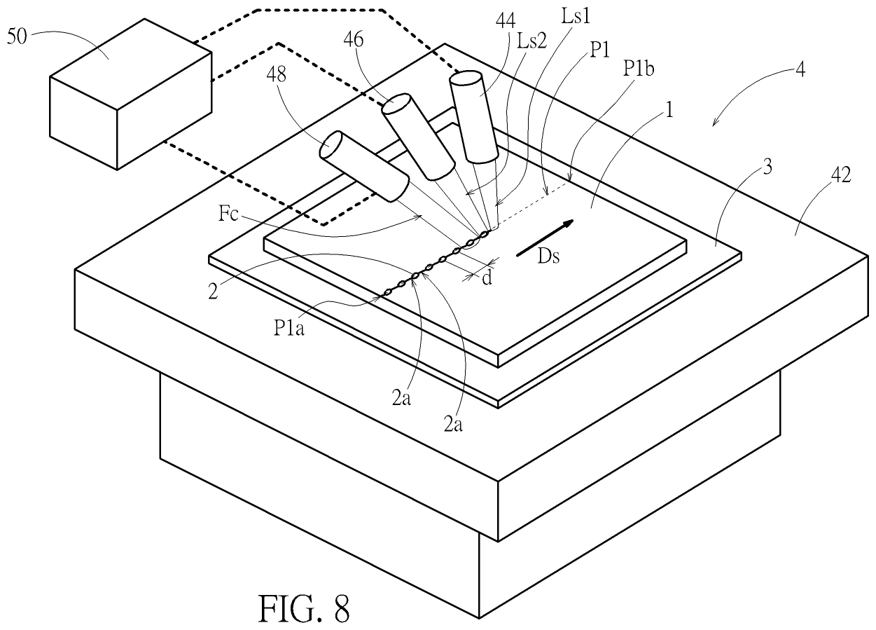

Please refer to FIG. 6 to FIG. 8. Referring to the step S100, the substrate 1 together with the flexible film 3 (referring to FIG. 2) is placed on the carrying platform 42 (as shown by FIG. 8); therein, the substrate 1 is attached to the flexible film 3 via an adhesive coated on the flexible film 3 (not shown in the figures). Referring to the step S102, a track (that is, equivalent to the cutting path P1) is defined on the substrate 1. The track includes a start point P1a (i.e. cutting start point) and an end point P1b (i.e. cutting end point). In practice, the position data of the track can be stored in the control module 50 in advance. The position data of the track can be an image. The control module 50 can first capture an image of the substrate 1 placed on the carrying platform 42 and compare it with the stored position data so as to define an actual track on the substrate 1 (i.e. a track relative to the carrying platform 42).

Then, referring to the step S104, the control module 50 controls the laser beam Ls1, generated by the laser generating device 44, to move from the start point P1a along the track (i.e. moving along the cutting path P1 in the movement direction Ds) and end at the end point P1b. At the same time, referring to the step S106, the control module 50 controls the heating device 46 to heat the track, i.e., heating the area of the substrate 1 containing the plurality of holes 2. Besides, referring to the step S107, the control module 50 controls the cooling device 48 to direct the cooling air flow Fc onto the track. Therein, the laser beam Ls1 forms the plurality of holes 2 on the substrate 1 along the track. The thermoelastic stress at the hole 2 can also cause lateral cracks 2a that propagate from the hole 2 approximately along the cutting path P1. For the other descriptions of the holes 2 and cracks 2a, please refer to the relevant descriptions of the holes 2 and cracks 2a in the foregoing, which will not be repeated in addition. The heating device 46 can use another laser generating device to generate another laser beam Ls2 for heating. For the other descriptions of the laser generating device, please refer to the relevant descriptions of the laser generating device 32 in the foregoing, which will not be repeated in addition. The cooling device 48 can be realized by a fan. For the other descriptions of the cooling device 48, please refer to the relevant descriptions of the cooling device 34 in the foregoing, which will not be repeated in addition. In the movement direction Ds, the laser beam Ls2 is arranged behind the laser beam Ls1, the cooling air flow Fc is arranged behind the laser beam Ls2, and the laser beam Ls1, the laser beam Ls2, and the cooling air flow Fc move simultaneously. This arrangement enhances the effect of thermoelastic stress on the propagation of the cracks 2a, so that the cracks 2a between any adjacent two of the holes 2 can be close to and connected to each other, as shown by FIG. 4. For the other descriptions of the propagation of the cracks 2a, please refer to the relevant descriptions of the propagation of the cracks 2a in the foregoing, which will not be repeated in addition.

Afterwards, referring to the step S108, if necessary, a force can be applied to the substrate 1 to split the substrate 1 along the plurality of holes 2 into several cut sheets 1a and 1b. For example, the cut sheets 1a and 1b of the substrate 1 can be separated along the plurality of holes 2 (or the cutting path P1) by stretching the flexible film 3 (as shown in FIG. 5, pulling the flexible film 3 away from the left and right sides). The stretching of the flexible film 3 can be achieved by arranging a clamp on the carrying platform 42 to hold the flexible film 3 and pull it outwards. The stretching of the flexible film 3 can be achieved by another device. For the other descriptions of the stretching of the flexible film 3, please refer to the relevant descriptions in the foregoing, which will not be repeated in addition.

As discussed above, the equipment 4 according to the third embodiment can form the holes 2 and the cracks 2a on the substrate 1 and propagate the cracks 2a on the same machine, and then complete the cutting of the substrate 1, which can increase the precision of the cutting track. Besides, the equipment 4 can complete or nearly complete the cutting planes 2b extending roughly along cutting path P1 by using thermoelastic stress to generate and propagate the cracks 2a, which eliminates or at least greatly reduces the opportunity to split the substrate 1 with a cleaving knife, helping to provide more flat cutting planes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for cutting substrate, comprising:
(a) forming a cutting path on a substrate;
(b) applying a laser beam onto the substrate to form a plurality of holes with a pitch less than or equal to 20 micro meters along the cutting path; and
(c) increasing a temperature of an area of the substrate containing the plurality of holes.

2. The method for cutting substrate according to claim 1, further comprising:
applying force to separate the substrate along the plurality of holes.

3. The method for cutting substrate according to claim 1, further comprising:
in the step (c), after the temperature of the substrate is increased, decreasing the temperature of the substrate.

4. The method for cutting substrate according to claim 3, wherein in the step (c), a cooling air flow is directed to decrease the temperature of the substrate.

5. The method for cutting substrate according to claim 1, wherein in the step (b), the laser beam is a pulse laser beam.

6. The method for cutting substrate according to claim 1, wherein in the step (c), another laser beam is used to increase the temperature of the substrate.

7. The method for cutting substrate according to claim 6, wherein in the step (c), the laser beam that increases the temperature is a carbon dioxide laser beam.

8. The method for cutting substrate according to claim 1, wherein the substrate is a substrate of glass material.

9. The method for cutting substrate according to claim 1, wherein an inner diameter of the holes is less than 3 micro meters.

10. An equipment for cutting substrate, comprising:
a carrying platform, the carrying platform carrying a substrate;
a laser generating device, the laser generating device generating a laser beam;
a heating device; and
a control module, the control module controlling the laser beam generated by the laser generating device to move on the substrate along a track, and then guiding the heating device to heat the substrate along the track.

11. The equipment for cutting substrate according to claim 10, wherein the laser beam is a pulse laser beam.

12. The equipment for cutting substrate according to claim 10, wherein the heating device generates a carbon dioxide laser beam to heat the substrate.

13. The equipment for cutting substrate according to claim 10, further comprising a cooling device, wherein the cooling device directs a cooling air flow to the track.
